(19) United States
(12) Patent Application Publication
(10) Pub. No.: US 2023/0107081 A1
(43) Pub. Date: Apr. 6, 2023

(54) FRAME KITS FOR STORAGE COVERS

(71) Applicant: Douglas Horner, Brookston, IN (US)

(72) Inventor: Douglas Horner, Brookston, IN (US)

(21) Appl. No.: 17/449,531

(22) Filed: Sep. 30, 2021

(51) Int. Cl. A47J 37/07

(52) U.S. Cl. CPC A47J 37/0786

(57) ABSTRACT

A frame for storage covers is disclosed. A frame can be assembled from various sized and shaped frame segments to have substantially the same shape as the opening of a flexible cover. The rigid frame is separate from but can be attached to a flexible cover which the user may or may not already possess. After attaching the frame to a cover, the opening of the flexible cover remains rigid and open, allowing for easy covering and uncovering of an object. The variable size and shape of the assembled frame kit allows the user to attach the frame to various covers. Additionally, the frame is simple to remove from the cover in the event a new cover is purchased or to reconfigure and attach the frame to a different cover.

### BACKGROUND

The present disclosure relates to flexible covers used to cover objects and protect them from deterioration due to causes such as exposure to weather conditions, dust and dirt, air pollutants, or other environmental factors.

Placing a cover over an object can be time-consuming, cumbersome, and frustrating. For example, most outdoor covers have a non-rigid opening that must be perfectly placed over the item so that it is properly covered. Often, these covers snag on the item to be covered, twist and deform during placement, or get blown around by wind, which makes covering outdoor objects with flexible covers tedious. Removing an outdoor cover so the underlying object can be used can be equally difficult. Snagging or a risk of tearing or ripping the cover requires a user to remove these flexible covers with caution and care. Similarly, covers may be supplied with straps, clips, or other fasteners to attach the cover to the item that is to be protected to prevent the cover to be blown off or damaged by wind. But unfastening and refastening the cover so that the item can be used can be equally cumbersome and frustrating to the user.

Known covers that contain a frame cannot be implemented in a cover that a user already owns. Additionally, the known framing solutions may be physically incorporated or embedded into the cover structure and cannot be simply installed and uninstalled as needed. Outdoor covers come in many different shapes and sizes. For example, various sized grills, smokers, and cookers might all have different sized covers. Similarly, vehicles stored outdoors may take on a variety of sizes and shapes that vary greatly, as do tools and lawn and garden items which may need to be stored outdoors. Likewise, furniture, both indoor and outdoor, may need covering for extended periods of time with covers of various shapes, sizes, and opening configurations.

The prior art does not offer an easy to assemble, easy to use solution in such a wide array of applications. Thus, there is a need for improvement in this field to address the above problems and provide other benefits as described below.

### SUMMARY

Frames for flexible storage covers are provided by the present disclosure. Such frames may be constructed from multiple segments which are designed to couple together via connector assemblies. Structures for attaching the assembled frame to a flexible cover are also described. In some embodiments, the segments are provided in varied lengths and shapes, including straight segments and curved segments, such that they may be assembled in different combinations to form frames of various shapes. The segments may be connected through connector assemblies which are integrally formed in the segment ends, such as male-to-female mating shapes in the segment ends, separable coupling components designed to receive the segment ends, or combinations of such connector types. The various parts may be provided in kits which are adaptable to be assembled for use with various sizes and types of covers.

Methods for using frame attachments with covers are also provided. Such methods may include assembling a plurality of frame segments together to form a frame shape, attaching the frame shape to a flexible cover to hold the mouth of the cover in an open position, and covering an item with the combined cover and frame construction. Some methods may include removing the frame after the item is covered such that the frame assembly may be reused in covering additional items. Methods of use extend to removing the cover, using the item, and replacing the cover, as well as reassembling the segments to form new frames in different shapes or sizes for use with differently-sized covers.

Further forms, objects, features, aspects, benefits, advantages, and embodiments of the present disclosure will become apparent from a detailed description and drawings provided herewith.

### BRIEF DESCRIPTION OF THE DRAWINGS

FIG. 1A is a top view of a cover attachment that illustrates assembly of a frame by connecting frame segments via connector assemblies.

FIG. 1B is a top view of a cover attachment that illustrates an example of an assembled frame from FIG. 1A.

FIG. 2 illustrates attachment of the cover attachment of FIGS. 1A-1B to a cover via attachment assemblies.

FIG. 3 illustrates the cover attachment and the cover being placed over an item.

FIG. 4 is an expanded view of the attachment assembly of FIGS. 1-3 connecting the frame to a cover.

FIG. 5 is a top view of an embodiment of a cover attachment assembled in the shape of a circle.

### DESCRIPTION OF THE SELECTED EMBODIMENTS

For the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates. One embodiment of the disclosure is shown in great detail, although it will be apparent to those skilled in the relevant art that some features may not be shown for the sake of clarity.

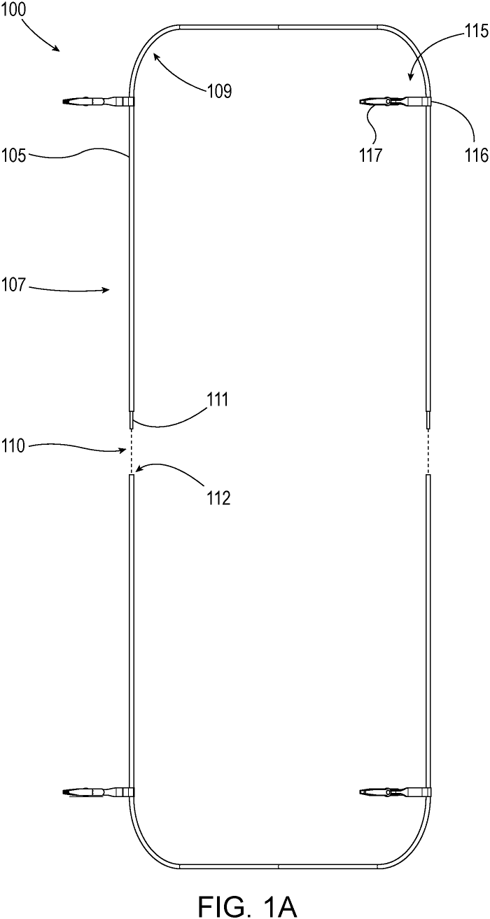

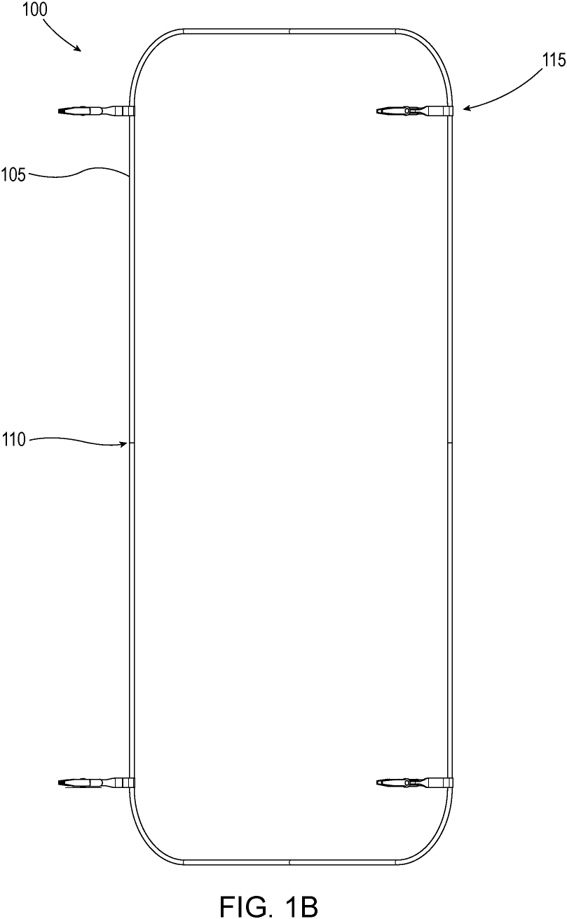

FIG. 1A illustrates a unique cover attachment that connects to a cover to provide structural support for the mouth of the cover. In FIG. 1A, cover attachment 100 includes a frame 105. The frame 105 is comprised of a plurality of frame segments 107, 109. The plurality of frame segments 107, 109 are coupled together via a connector assembly 110 to form frame 105, which has a planar shape. Cover attachment 100 additionally includes a plurality of attachment assemblies 115 that are attached to frame 105 via fasteners 116. The attachment assemblies 115 include couplers 117 for connecting the frame 105 to a flexible cover.

As depicted in FIG. 1A, the frame 105 has a generally rectangular shape with rounded corners. The shape of the frame 105 is determined by the length and bend of frame segments 107, 109. The frame segments 107, 109 may be in multiple shapes or configurations. As shown in FIG. 1A, frame segment 107 has a generally linear shape while frame segment 109 has a generally rounded shape with a radius of curvature such that the two ends of the segment are not aligned. By attaching frame segments together of various lengths and bends, frame 105 may be assembled to have a wide variety of shapes to compliment the shape of the cover that the cover attachment 100 is being connected to.

Frame segments 107, 109 may be made of any suitable material durable enough to withstand intended use conditions, for example, outdoor weather conditions. In a preferred embodiment, by way of example, frame segments 107, 109 are made of anodized aluminum tubing. However, frame segments 107, 109 may alternatively be made of plastic rods, plastic tubing, nylon, or any other suitable polymer or alloy or combinations thereof. Additionally, it should be appreciated that frame segments 107, 109 may be hollow tubes or comprised of solid material. Materials should be selected such that frame segments and the assembled frame are more rigid than the perimeter of the mouth or opening of the flexible cover to be used with the frame.

Frame segments 107, 109 are connected together via a connector assembly 110. Referencing FIGS. 1A and 1B, a preferred connector assembly 110 of the present embodiment includes a male connector 111 and a female connector 112. In this embodiment, each frame segment 107, 109 includes a male connector 111 at one end and a female connector 112 at another end. By attaching the male connector 111 of one frame segment with the female connector 112 of another segment, frame segments 107, 109 are coupled together, as shown in FIG. 1B, to form frame 105. However, various configurations are envisioned in the present disclosure. For example, one frame segment 107 may include two male connectors 111 at each end and connect to two frame segments, one at each end, that both contain two female connectors 112. In this configuration, every “odd” frame segment would have two male connectors 111 and every “even” frame segment would have two female connectors 112.

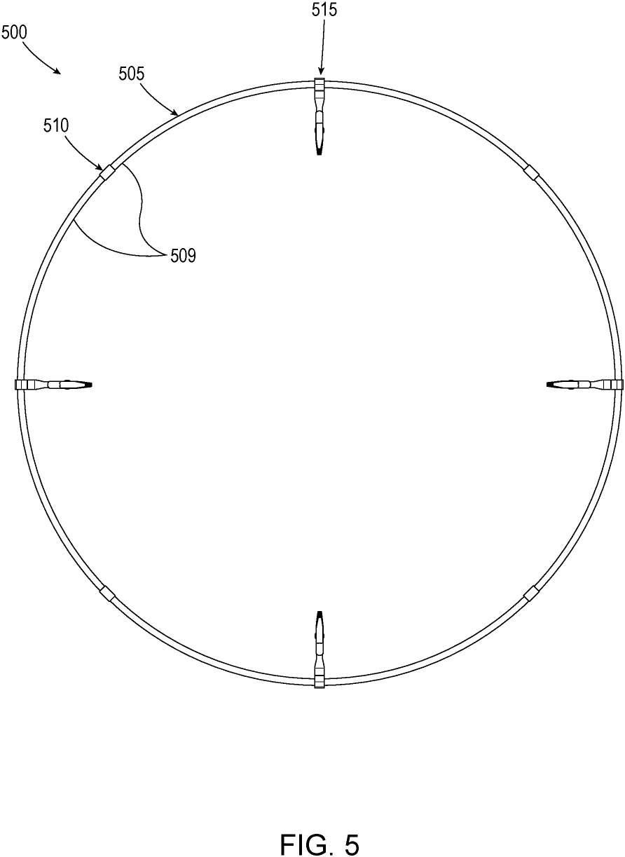

However, cylindrical male-to-female connectors 111, 112 shown in FIG. 1A are not the only types of connection assemblies 110 envisioned in the present disclosure. Other mating structures or shapes may be chosen for male connector 111 and female connector 112. For example, connector assembly 110 may include male and female threads to screw frame segments 107, 109 together. Additionally, connector assembly 110 may include a leg slider, wherein one frame segment is telescopically attached to a second frame segment via a biased locking mechanism that fits into a hole punched into the second frame segment. Alternatively, connector assembly 110 may include a cylindrical coupler, which is an external piece separable from the segments that receives multiple segment ends to connect one frame segment to another, such as coupler 510 shown in FIG. 5 and described further below. Such connector assemblies may be augmented with set screws, compression fittings, or other locking or latching mechanisms. Any other suitable connection method is also envisioned in the present disclosure, such as adhesives, interference fits with or without internal cabling, biased prongs or harnesses, or any combinations of the foregoing mechanisms.

Connection assemblies may be provided in configurations where the connected frame segments are not co-linear; for example, connections assemblies may be provide in angled corners or t-shape configurations such that the adjoining segments connected thereby are maintained at substantially right angles relative to one another. Additional angles and orientations may be implemented by those skilled in the art and are considered within the scope of disclosure without further elaboration.

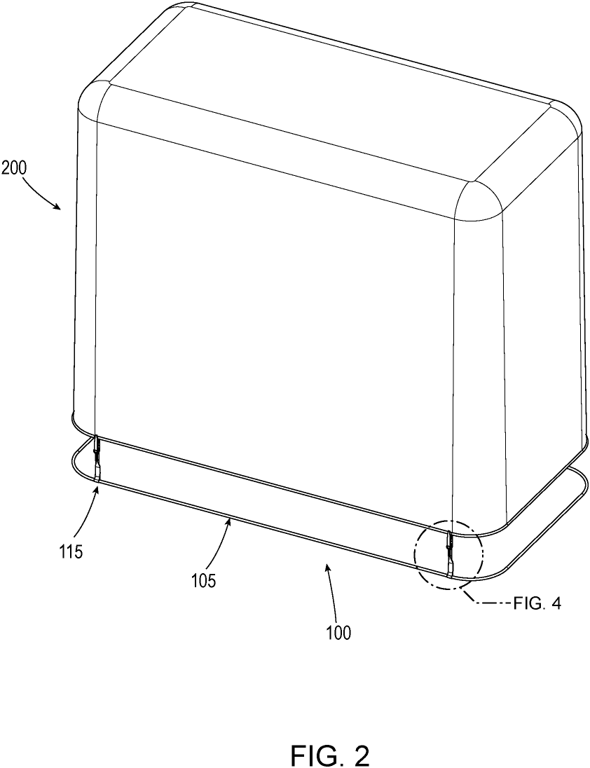

FIG. 2 illustrates the cover attachment 100 implemented with a cover. In this embodiment, the frame 105 is attached to a cover 200 via a plurality of attachment assemblies 115 attached to the mouth of the cover 200. In this embodiment, the frame 105 sits below the cover 200 a distance equal to the length of the attachment assemblies 115. In this configuration, a user of cover attachment 100 is able to easily attach and detach the frame 105. A user of cover attachment 100 also can easily grab the frame 105 as a means to manipulate the cover 200. Other embodiments of the present disclosure are also envisioned. For example, in another preferred embodiment, the attachment assemblies 115 are attached to interior surfaces of the cover 200, such as a seam, for example. In this configuration, frame 105 may sit flush or aligned with the mouth of cover 200, such that the frame supports the mouth in an open configuration, but is not visible, or is only slightly visible, when attached similar to FIG. 2 and in place over the item to be covered. Other embodiments are also envisioned by the present disclosure. For example, the frame 105 could be attached to the cover 200 via attachment assemblies 115 anywhere on the interior of the cover, such that the frame 105 is not flush with the mouth of cover 200, or the frame 105 could be attached anywhere on the exterior of cover 200, so long as the cover is supported in an open configuration. It is understood that frame kits of the present disclosure are compatible with covers including variable-sized openings, for example, covers which include a drawstring along the mouth of the cover to tighten the cover around an object. For example, attachment assemblies may be of sufficient length to permit a drawstring to contract the mouth opening without compressing or modifying the shape of the assembled frame.

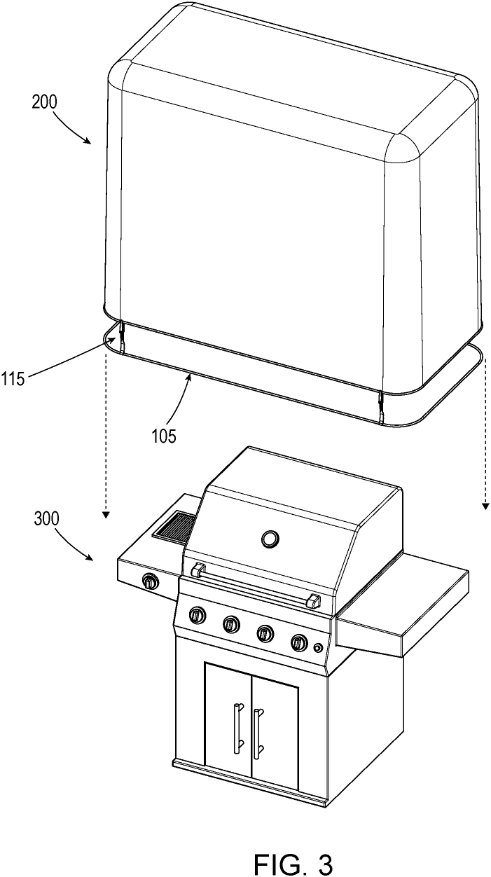

FIG. 3 illustrates the frame 105 supporting the mouth of cover 200 is an open configuration, such that frame 105 and cover 200 both easily slide over an object. In this example, cover 200 is the cover for an outdoor grill 300. Because the frame 105 is configured with frame segments 107, 109 (seen in FIG. 1B) that match the shape of the mouth of cover 200, the frame 105 and cover 200 are easily placed over grill 300 without any snags or hassle. While FIG. 3 depicts a grill 300 and a corresponding cover 200, any size cover could be implemented with the present disclosure to cover any object. By way of non-limiting examples, the cover attachment 100 could be implemented with covers for grills (round or rectangular), smokers, cookers, lawn mowers, tractors, ATVs, outdoor furniture, trampolines, cars, motorcycles, plants or landscaping features, or any other flexible cover. Such flexible covers may be manufactured in multiple sizes directed to the same category of item, such as grill covers for standard sizes such as 3', 4', 5', 6', or even greater lengths. Similarly, vehicle covers may range from around 12' to 20' in length and around 6' to 8' in width. Covers need not be limited to outdoor uses, and the frame assemblies are suitable for use with indoor covers such as furniture covers and other coverings needed for storage and protection, such as furniture covers to protect from fading and sun exposure in buildings used infrequently or seasonally. The frame segments described herein can be assembled to fit any such cover. By combining frame segments 107, 109 of various lengths and bends, a desired shape that matches the shape of the mouth of a cover 200 can be assembled and implemented.

Optionally, components of the frame assembly may use materials such that the assembled frame is sufficiently heavy to weigh the cover down and prevent the cover from loss or damage due to wind or other intrusions, yet still be light enough to permit the user to place and remove the cover with ease. For example, frame segments may be weighted such that the assembled frame weighs several pounds, sufficient to prevent the cover from being uplifted by wind. Alternatively, connection assemblies may be relatively heavy to achieve the same result, which may permit lighter, cheaper materials to be used for the frame segments. Heavy frames may also be used to keep the mouth of the cover tight or close to a ground or floor surface, thereby preventing wind of other intrusions (such as dirt, debris, or pests) from entering the covered area. Additional embodiments may include removable weights that can be selectively engaged with the assembled frame. In other configurations, a stake connected to the frame may be driven into the ground to hold the frame and connected cover down. Such frames may be used to alleviate the burden and frustrations of securing the flexible cover to the covered item or other stationary objects, as well as related unfastening when the user desires to use the item.

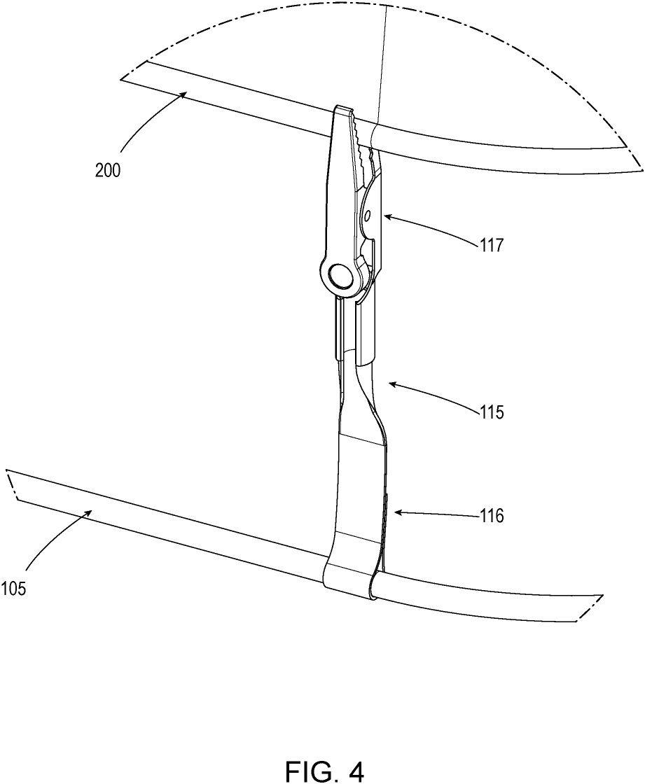

FIG. 4 is a close-up view of the attachment assembly 115 connecting the frame 105 to the cover 200 in the same configuration depicted in FIG. 2. The attachment assembly 115 includes a fastener 116 and a coupler 117. In a preferred embodiment, the fastener 116 is a nylon strap that is about 1 inch wide and 6 inches long and the coupler 117 is an alligator clip, meaning a spring clip with a set of teeth on the inside edges of the grasping portions of the clip. It should be appreciated that the fastener 116 could be of any length and/or width suitable to connect the frame 105 to the cover 200. Additionally, the fastener 116 could be made of any suitable material, such as nylon, leather, plastic, or even metal. Fastener 116 may be flexible or rigid. In this preferred embodiment, the coupler 117 is an alligator clip that is made of plastic or metal However, other materials such as various polymers or the like may be implemented. However, other variations of fastener 116 are envisioned in the present disclosure. For example, any means for connecting the frame 105 to the cover 200 may be employed, such as hook and loop attachment, a buckle, rope or string, or the like. Additionally, the coupler 117 could be any coupling means such as various types of clips, hooks, buckles, key rings, clamps, pins, adhesives, carabiners, or the like. The fastener 116 and coupler 117 need not be separable or distinct components. For example, attachment assembly 115 may be a spring clip with one end for grasping the cover 200 and a hole at the other end through which frame segment 105 passes, thereby attaching the frame to the cover. In another embodiment (not shown), attachment assembly 115 may be a two-sided clip, for example a two-headed alligator clip, where the mechanisms for connecting to both the frame assembly and the cover are substantially the same.

FIG. 5 illustrates another embodiment of the present disclosure. In this embodiment, cover attachment 500 includes a circular-shaped frame 505. Each frame segment 509 has a radius of curvature wherein the ends of the frame segment do not align. When these frame segments 509 are connected via connection assembly 510, they form a circular-shaped frame 505. In this embodiment, a plurality of attachment assemblies 515 are implemented to connect circular-shaped frame 505 to a cover with a circular opening (not shown), such as may be used with kettle- or egg-shaped outdoor grills. As depicted in FIG. 5, frame segments 509 are connected via connection assembly 510, which, in this example, are cylindrical couplers. The cylindrical couplers 510 attach to the exterior of the ends of two frame segments to connect the two frame segments. However, it should be noted that cylindrical couplers 510 are not exclusively required on circular-shaped frame 505 and male-to-female connection assembly 110, 111, 112 (seen in FIG. 1A) is not exclusively required for a rectangular shaped frame, such as frame 105. These connection assemblies 110, 510 are available for any desired frame-shape, as disclosed herein.

The multiple pieces of the present disclosure may be available in a kit. Said kit may include a plurality of frame segments 107, 109, 509, a plurality of attachment assemblies 115, 515 and a plurality of connector assemblies 110, 510 (if not built into the ends of frame segments 107, 109, 509) in both straight and angled configurations. It is contemplated that the kit may include an instruction manual. It is also contemplated by the present disclosure that the kit may contain a travel/carry case for the frame 105, 505 and/or the parts thereof included with the kit. The kits may include multiple selections of frame segments 107, 109, 509 so that the frame 105, 505 formed from the frame segments 107, 109, 509 is the same shape as the cover it is to be attached to. For example, a kit may include frame segments depicted in FIGS. 1A and 1B to attach to a rectangular cover 200. Alternatively, for example, a kit may include frame segments 509 depicted in FIG. 5 to attach to a circular cover (not shown).

While certain embodiments have been illustrated and described in detail in the drawings and foregoing description, the same is to be considered as illustrative and not restrictive in character, it being understood that all changes, equivalents, and modifications that come within the spirit of the following claims are desired to be protected.

1. A cover attachment for a flexible cover, comprising:
a plurality of frame segments, wherein each frame segment has a length between a first end and a second end, the first end operatively couplable via a connector assembly to one or more other frame segments; and
a plurality of attachment assemblies, wherein each attachment assembly is operatively couplable to the frame segments and may be configured to attach to a flexible cover.

2. The cover attachment of claim 1, wherein the length of one or more frame segments varies from the lengths of the other frame segments.

3. The cover attachment of claim 2, wherein one or more frame segments has a radius of curvature such that the two ends of such frame segments are not aligned.

4. The cover attachment of claim 3, wherein a plurality of frame segments are connected to form a first frame with a first closed planar shape.

5. The cover attachment of claim 4, wherein the frame segments are reconfigurable to be connected to form a second frame with a second shape.

6. The cover attachment of claim 3, wherein the frame segments are formed from anodized aluminum tubing.

7. The cover attachment of claim 1, wherein the one or more attachment assemblies comprise an alligator clip and a strap between 3 and 7 inches long.

8. The cover attachment of claim 1, wherein the connector assembly is formed by a first mating shape defined by the first end of a first frame segment and a complementary second mating shape defined by the second end of a second frame segment.

9. The cover attachment of claim 1, further comprising a plurality of connector assemblies in the form of cylindrical couplings, separable from the frame segment first ends and second ends and adapted to receive the ends of multiple frame segments, wherein the first ends and the second ends of the frame segments are adapted for insertion into the cylindrical couplings.

10. The cover attachment of claim 1, further comprising a plurality of connector assemblies in the form of corner couplings, separable from the frame segment first ends and second ends and adapted to receive the ends of multiple frame segments, wherein the first ends and the second ends of the frame segments are adapted for insertion into the corner couplings, such that the adjoining frame segments coupled by the corner couplings are not co-linear and are maintained at angles relative to one another.

11. The cover attachment of claim 1, further comprising a flexible cover having a mouth, wherein a plurality of frame segments are connected to form a frame with a planar shape substantially similar to the shape of the mouth, wherein the frame is connected to the flexible cover by one or more of the attachment assemblies to hold the mouth in an open position.

12. A method for assembling and using a cover attachment, comprising:
assembling a plurality of frame segments together via connector assemblies to form a frame, wherein the frame has a planar shape;
attaching a plurality of attachment assemblies to said plurality of frame segments;
attaching the frame via the attachment assemblies to a flexible cover, wherein the frame holds the mouth of the flexible cover in an open position; and
placing the attached frame and flexible cover over an item.

13. The method of claim 12, wherein the attachment assemblies are attached to the mouth of the flexible cover to hold the mouth of the flexible cover open, such that there is a gap between the mouth of the flexible cover and the frame.

14. The method of claim 12, wherein the attachment assemblies are attached to the interior of the flexible cover to hold the flexible cover open, such that the frame is aligned with the mouth of the flexible cover.

15. The method of claim 12, further comprising:
taking the attached frame and flexible cover off of the item;
using the item; and
returning the attached frame and flexible cover over the item.

16. The method of claim 12, comprising:
disassembling the frame; and
reassembling the plurality of frame segments together via connector assemblies to form a second frame, wherein the second frame has a second shape which differs from the planar shape.

17. A kit for use in holding the mouth of a flexible cover open, the kit comprising:
a plurality of frame segments having a length and a first end and a second end, wherein the frame segments are operatively couplable to each other via connector assemblies to form a frame that has a planar shape;
a plurality of attachment assemblies, wherein each attachment assembly is operatively couplable to the frame segments and may be configured to attach to a flexible cover.

18. The kit of claim 17, wherein the length of one or more frame segments varies from the lengths of the other frame segments, wherein one or more frame segments has a radius of curvature such that the two ends of such frame segments are not aligned.

19. The kit of claim 18, further comprising a plurality of separable connector assemblies.

20. The kit of claim 18, further comprising a storage case adapted to hold and transport the contents of the kit in a disassembled state.
